(19) United States
(12) Patent Application Publication
(10) Pub. No.: US 2003/0136769 A1
(43) Pub. Date: Jul. 24, 2003

(54) Laser ablation technique using in IC etching process

(76) Inventors: Yue-Yeh Lin, Hsin-Chu (TW); Shu-Ping Chen, Taipei (TW); Ya-Pai Yeh, Tainan (TW)

Correspondence Address: RABIN & BERDO, P.C., Suite 500, 1101 14th Street, N.W., Washington, DC, 20005, US

(21) Appl. No.: 10/052,520

(22) Filed: Jan. 23, 2002

(51) Int. Cl. B23K 26/38

(52) U.S. Cl. 219/121.69; 219/121.61; 219/121.8; 219/121.73

(57) ABSTRACT

The present invention relates to a method of laser technology using in IC etching process, which uses by controlling the power of laser, repetition rate, timing of operation and modulation of laser beam's focus to apply in IC etching process to ablate the various materials on the surface of a wafer.

### BACKGROUND

1. Technical Field of the Invention

This invention relates to a method of laser ablation technique using in integrated circuit (IC) etching process, which simplifies the fabricating processes and flow charts of ICs and the like.

Laser can focus the energy by the optics and absorb by the surface of object. Once the laser energy density exceeds the threshold of material breakdown the surface begins to evaporate or dissociate in vapor phase then remove from the substrate. This material remove process by laser is defined as ablation, which mechanism has physical and chemical reaction. For the application of laser ablation technique is not only limited the materials of works to be fabricated but also can simplify the fabrication processes. Therefore, the laser ablation technique has widely applying in various industries.

Moreover, laser ablation can process various materials, hard or soft, metallic or non-metallic, insulated or conductive, such as silicon, germanium, tantalum, nickel, iron, tungsten, silicon oxide (SiO₂), copper, etc, which are able to effective control under an accurate dimension during fabricating. Especially, the laser technique has more effective utilized to fabricate the magnetic and ceramic materials, such as Mn—Zn ferrite, Al₂O₃ and TiC.

The molecules of processing material that can directly absorb the high-level energy laser photons, i.e. ultra-violet (UV) laser, which cause to the stable electronics easily excite from the energy ground level to unstable level then break molecule bond and finally evaporate from the surfaces of said material. Laser ablation technique can perform the photochemical effect for etching and can remove the various materials, which have been deposited in every layer of wafer. Predictably, effective utilizing laser ablation technique is a necessary trend in IC industry.

2. Description of the Prior Art

Generally speaking, the conventional fabricating process of IC, especially in the front end of wafer processing, has many repeated processes. Several processes can define a specific layer, which accompanied by a mask. Each layer comprises all or some of major processing steps, such as epitaxy, photo-lithography, etching, stripping, diffusion, ion implantation, deposition or chemical mechanical polishing (CMP) to add or ablate the materials on the surface of said wafer. These complicated and repeated steps have been using in this industry.

### SUMMARY OF THE INVENTION

It is an object of the present invention relates to a method of laser ablation technique using in IC etching process, which uses the features of laser beams direct focus on the surface and ablate the materials on the surface of wafer without photolithography exposure and development.

It is therefore a board object of the present invention provides an effective process control of high/low power level (power density), number of pulse (repetition rate) and laser operating duty cycle (pulse width) of laser beams to ablate various materials and depths of said wafer.

It is further object of the present invention provides an appropriate optical lens assembly to ablate various materials and to accurate the ablated area, shapes and depths of said wafer.

It is foregoing objects and others are accomplished in accordance with the present invention by providing this method to reduce the photolithography processes, and to achieve the subject matter of energies saving and environment protection.

### BRIEF DESCRIPTION OF THE DRAWING

For a better understanding of the present invention as well as other objects and features herein disclosed, reference is made to following detailed disclosed of this invention taken in conjunction with drawings herein:

FIG. 1, is a schematic diagram of the present invention

FIG. 2, is a flow chart of the present invention

### DESCRIPTION OF TERMS

(11) laser source
(12) scanning lens assemble
(13) laser beams
(14) focusing lens assemble
(15) wafer
(16) X-Y moving stage
(17) shutter
(18) laser power supplier
(19) chiller

### DESCRIPTION OF THE PREFERRED EMBODIMENTS

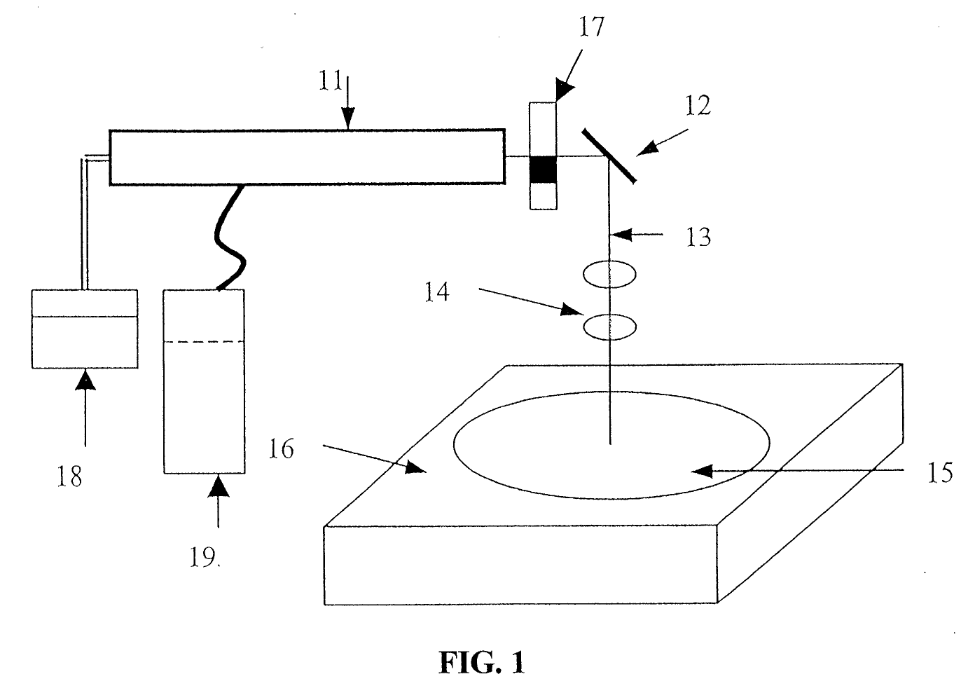

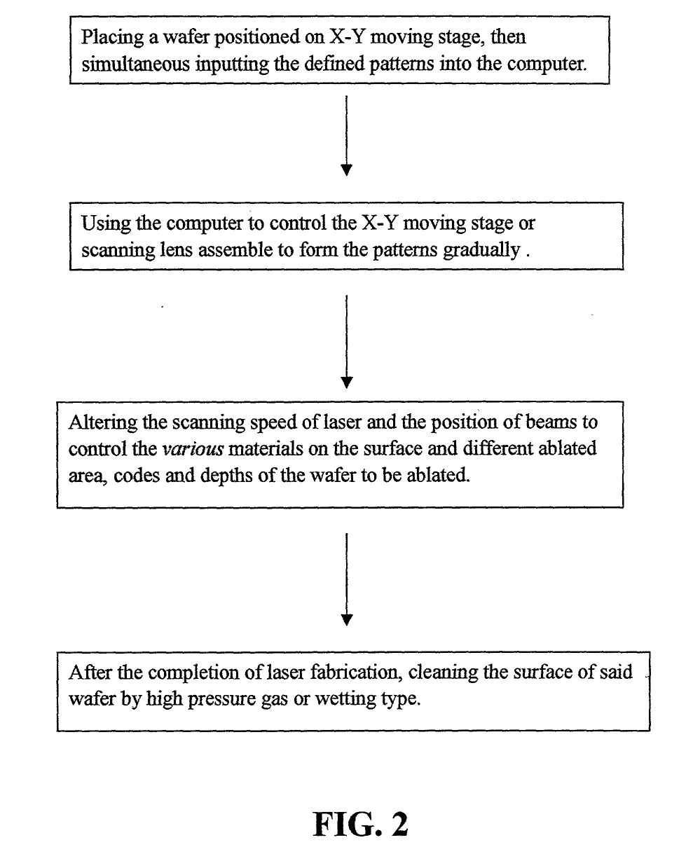

Please refer to FIGS. 1 and 2, shown as the present invention relates to a method of laser technique using in IC etching process, whereby the laser beams have physical and chemical effects onto various materials to ablate the materials on the surface of a wafer.

Various materials has different ablating rate, which determined by laser power, specific materials optical properties, energy bonding, dissociation heat and lattice in a wafer. While the ablating process performs, the optimal parameter can be achieved by altering the power of laser, repetition rate and pulse width to ablate the various materials in said wafer as well as to control the depths of said materials. By means of adjusting the output power of laser power supplier (18), modulating the timing of shutter (17) and the moving rate of X-Y moving stage (16) or scanning rate of scanning lens assemble (12), and adjusting the focusing position of focusing lens assemble (14), whereby a solution of this focused laser beams which is able to accurate control the ablated area, shapes and depths to be ablated. As a result, the focus of laser beams that is the concentration of laser energies, herein the more approaching materials of said wafer, which are ablated. To prevent over heat in the laser source, it is necessary having a chiller (19) to maintain a constant temperature while said system is working.

Please refer to FIGS. 1 and 2, shown as modulating the power—high or low—of the laser source (11) and operation timing—short or long—to control the various materials on the surface of said wafer (15) and different depths of said wafer (15) to be ablated. Furthermore, adjusting the position of the focusing lens assemble (14) to ablate the various materials on the surface of said wafer (15) and to control the ablated area, shapes and depths of said wafer (15), the processing steps as follows: placing the wafer at a certain position of the X-Y moving stage (16) and simultaneous inputting the defined patterns into the computer, whereby using said computer to control the X—Y moving stage (16) or scanning lens assemble (12) forms said patterns gradually. Then, altering the scanning speed of laser and the position of laser beams to control the various materials on the surface and different ablated area, shapes and depths of said wafer (15) to be ablated. The ablated material may evaporate as gas or redeposit in particle form on the working region. Finally, as completion of laser fabrication, cleaning the surface of said wafer by high-pressure gas or wet clean process.

While this invention has been described in conjunction with particular embodiments, it is evident that alternatives, modifications and variations will now be apparent to those skilled in the art. Accordingly, the present invention is intended to embrace all such alternatives, modifications and variations and fall within the spirit and scope of the appended claims.

What is claimed is

1. A method of laser ablating technique using in IC etching process, comprises a laser beams source, a scanning lens assemble, laser beams, a focusing lens assemble, a X-Y moving stage, a shutter, a power supplier and a chiller, whereby said structure controls the power level of laser and the timing of operation to ablate the various materials on the surface of wafer, whereby adjusts said focusing lens assemble to concentrate the focus of laser beams and to alter the focusing position of laser beams, wherein controlling various materials of the ablated area, codes and depths on the surface of the wafer to be ablated.

2. The method of claim 1, the etching process comprises the steps of: placing said moving stage at a positioned and simultaneous defining the pattern to input into the computer, whereby said computer controls said moving stage or said scanning lens assemble to form said pattern, wherein altering the scanning speed and focusing position of said laser beams to control various materials of the regions, shapes and depths on the wafer surface to be ablated, since completed laser operation whereby the high pressure or wetting to rinse the surface of said wafer.

3. The method of claim 1, wherein said shutter is capable of adjusting the operation timing of laser beams.

4. The method of claim 1, wherein said power supplier is capable of adjusting the output power of laser beams.

5. The method of claim 1, wherein said chiller is using in cooling temperatures to maintain a constant temperature, herein said chiller can be a icy-water machine.
